(19) United States
(12) Patent Application Publication
(10) Pub. No.: US 2015/0103631 A1
(43) Pub. Date: Apr. 16, 2015

(54) TRAWL HEIGHT INDICATOR

(71) Applicant: Scantrawl AS, Aasgaardstrand (NO)

(72) Inventor: Henning Skjold-Larsen, Aasgaardstrand (NO)

(73) Assignee: Scantrawl AS, Aashaardstrand (NO)

(21) Appl. No.: 14/401,120

(22) PCT Filed: May 15, 2013
(86) PCT No.: PCT/IB2013/053966

§ 371 Date: Nov. 14, 2014

(30) Foreign Application Priority Data
May 16, 2012 (NO) 20120577

(51) Int. Cl. A01K 73/04; G01S 15/02; A01K 73/02

(52) U.S. Cl. CPC A01K 73/04; A01K 73/025; G01S 15/02
USPC 367/99

(57) ABSTRACT

A trawl sensor device for monitoring trawl doors and the distance of the trawl to the boom during trawling operations comprises at least one acoustic transmitter and receiver, the transmitter being adapted to be positioned such that an acoustic signal is transmitted towards the seabed at a forward-pointing angle, and means for communication between the sensor device and a vessel. The transmitted acoustic signal is reflected from the seabed and is received at this position and the distance between the acoustic transmitter and the seabed is calculated based on the difference in time between transmission and reception of the acoustic signal and the forward-pointing angle.

The invention relates to a system and a method for monitoring the height of fishing gear above the bottom during a fishing operation.

There is an ever-growing focus on the damage that trawl gear, such as bottom trawls, can cause to coral reefs and other habitats for fish propagation. At the same time, it is a fact that many species of fish live on the bottom, or just above it. There is therefore a wish to further develop trawl fishing so as to be able to fish using trawls on or close to the bottom without causing damage to the bottom sediments, and a major step in this connection is to find solutions for maintaining the trawl doors at a certain distance from the bottom. An irregular bottom, the presence of many rocks, boulders and other obstacles, and also fishing on slopes makes this difficult, and there is a need, in a simple and inexpensive manner, both to know the height of the trawl doors above the bottom and to identify possible obstacles ahead of the doors.

When fishing is semipelagic and pelagic, close to the bottom, it is desirable to maintain the trawl doors a certain height above the bottom, so that the doors do not hit large rocks and other obstacles on the bottom, and thus sustain damage.

Today, a number of different measuring systems and devices are available for monitoring a trawling process. These include systems for measuring the size of the opening of the trawl, the speed of the trawl relative to the water, the amount of fish caught by the trawl etc. Such information can be transmitted to the operator of the trawl and the trawl winches on the boat, thereby enabling them to take actions to optimise the trawling process.

During a trawling operation, the operator or skipper has a limited number of actions he can take to influence the geometry of the trawl in order to optimise the trawling process and thus the result of the fishing operation, for example:
Change the speed
Change the length of the trawl wires
Change the angle of the trawl doors
Turn

The trawl doors move in the direction of travel of the vessel, with an angle of attack of 30-40° to the direction of travel and varying roll and pitch angle, and it is desirable to be able to obtain information to allow the doors to go as close to the bottom as possible by identifying obstacles at an early stage.

The object of the invention is to provide an apparatus/system and method for monitoring the distance to the seabed for gear during trawling operations, which enable the fisherman to identify obstacles as early as possible and take the right decisions in time.

The object is achieved by means of the features set forth in the patent claims.

In an embodiment, a trawl sensor device according to the invention for monitoring trawl doors and the distance of the trawl to the bottom during trawling operations comprises at least one acoustic transmitter and receiver, the transmitter being adapted to be positioned such that an acoustic signal is transmitted towards the seabed at a forward-pointing angle, and means for communication between the sensor device and a vessel.

The acoustic transmitter and receiver are, in an embodiment, arranged in or at the same position and are constituted of, for example, an echo sounder or other device able to transmit and receive acoustic signals. The communication means for communication between the sensor device and the vessel may be cables, acoustic communication means or other cabled or wireless means for communicating by means of one-way or two-way transmission of signals between the sensor device and the vessel.

The sensor device may basically be a conventional sensor device as, for instance, the SS4 series of sensors produced by Scanmar AS or similar sensor modules. The sensor devices are adapted to be attached to the trawl, the trawl door, the clump or other points at which it is desirable to be able to determine the distance to the seabed.

In an embodiment, the acoustic transmitter is adapted to transmit the acoustic signal at an angle of 5-90 degrees, for example, at an angle of 30 degrees.

The sensor device comprises, in an embodiment, an angle sensor capable of measuring roll and pitch angle of the sensor device or the doors on which the sensor device is mounted; for example, the angle of the sensor device relative to the direction of travel can be determined. In this way, compensation can be made for the angular deviation caused by the position of the gear when determining the angle at which the acoustic signal is transmitted.

In an embodiment, the sensor device comprises a processor unit arranged in the sensor unit itself or on the vessel. There may also be a processor unit both in the sensor unit and on the vessel. A processor unit arranged on the vessel will receive signals from the sensor device and utilise them for different calculations, for example, to calculate the distance between the acoustic transmitter and the seabed based on the difference in time between transmission and reception of the acoustic signal and the forward-pointing angle, to calculate the height between the sensor device and the seabed a distance ahead of the sensor device in the direction of travel, and/or to calculate the height between the lower part of the gear and the seabed a distance ahead of the sensor device in the direction of travel.

In an embodiment the sensor device also comprises a GPS unit.

In another embodiment, the sensor device comprises a motor and a rotating mechanism for the purpose of changing the angle of the transmitted acoustic signal. This change can in some embodiments be controlled by an operator or can be calculated by the processor unit.

The invention will now be described with the aid of examples and with reference to the attached drawings.

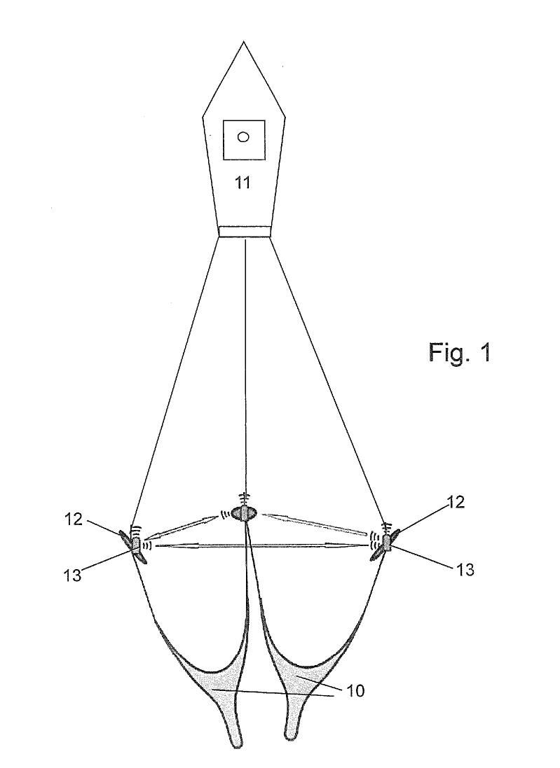

FIG. 1 is a schematic illustration of a trawl under tow by a vessel.

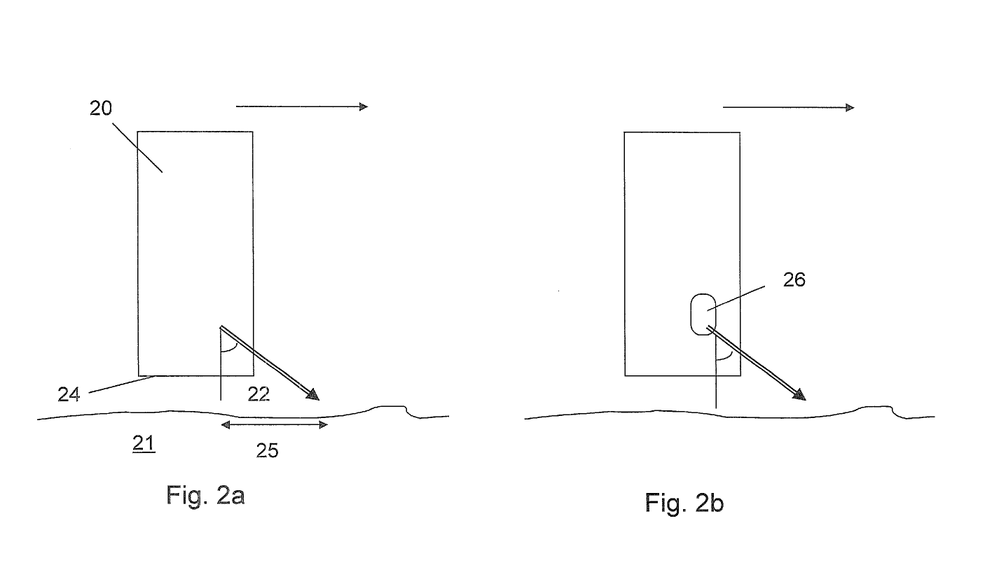

FIG. 2 illustrates a trawl door being pulled just above the seabed.

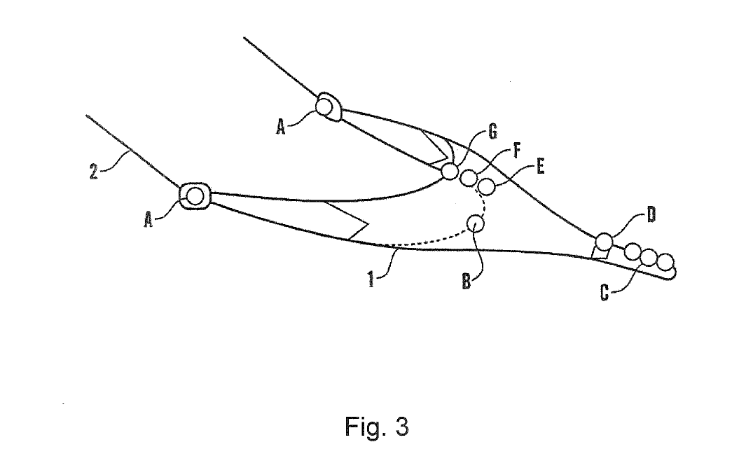

FIG. 3 illustrates possible positions on trawling gear in which the invention can be used.

FIG. 1 illustrates a trawl 10 that is being towed by a fishing vessel 11. In this illustration a twin trawl is shown, consisting of two trawls 10 linked together, but the principle is the same for one, two or more trawls towed by a vessel. The trawl 10 is spread by two trawl doors 12 that have an angle relative to the direction of travel of the vessel such that the sides of the trawl 10 are drawn apart.

The trawl doors 12 move in the direction of travel of the vessel 11, with an angle of attack of 30-40° to the direction of travel and varying roll and pitch angles. There is in this connection a need to be able to obtain information to allow the doors to go as close to the bottom as possible by identifying obstacles at an early stage. In order to be able to monitor the characteristics of the trawl doors 12, such as distance between them and their angular position, a sensor device 13 is provided on each of the trawl doors. The sensor devices 13 comprise at least measuring sensors, communications equipment and power supply unit. Examples of measuring sensors are distance sensor, angle sensor, depth sensor and temperature sensor. One or more of the measuring sensors can initially be inactive, but can be activated as the need arises to measure different parameters.

FIGS. 2a and 2b illustrate a trawl door 20, for example, a trawl door such as that shown in FIG. 1, which is moving in the direction of travel indicated by a horizontal arrow. The trawl door has a lower edge 24 that moves a distance above the seabed 21. From a position on the door, an acoustic signal is transmitted towards the seabed. The signal is reflected back to an acoustic receiver arranged at the same position on the door and the distance the signal has covered can then be calculated. The signal is transmitted at an angle 22 relative to the vertical plane in a forward-pointing direction in the direction of travel. When the position from which the signal is transmitted and the angle at which the signal is transmitted are known, the distance between the bottom edge 24 of the trawl door and the seabed 21 can be calculated at a distance 25 ahead of the trawl door by using trigonometry. The angle that is used can in some embodiments be changed so as to be able to vary the distance ahead of the trawl door that is to be measured. The distance that is necessary will depend on desired height above the bottom, the speed of the vessel, anticipated bottom conditions etc.

FIG. 2b shows a sensor device 26 that is attached to the trawl door 20 in the same way as in FIG. 1. All devices for transmission and reception of the acoustic signal are arranged inside the sensor device, in addition to possible other elements, such as a communications unit, other measuring sensors, power supply etc. In this case, the acoustic signal will be transmitted at a specific angle relative to the sensor device housing, where this angle is known.

The position of the sensor device on the trawl door, both distance to the lower edge and angular position, will be fixed, definite and known. The transmission angle for the acoustic signal will thus also be known and in the same way as described above for FIG. 2a, the distance between the lower edge of the trawl door and the seabed will be calculated at a distance ahead of the trawl door.

The calculations can be carried out in a unit connected to the transmitter and receiver arranged close to the position thereof, or can be sent to the vessel where they can be performed in a processor unit, for example, connected to the rest of the vessel's trawl monitoring equipment.

FIG. 3 shows possible positions of different sensors on trawl gear, where the sensors A, B and G are suitable positions for use of acoustic signal transmitters.

1. A trawl sensor device for monitoring trawl doors and the distance of the trawl to the bottom during trawling operations, comprising:
at least one acoustic transmitter and receiver, the transmitter being adapted to be positioned such that an acoustic signal is transmitted towards the seabed at a forward-pointing angle;
means for communication between the sensor device and a vessel.

2. A sensor device according to claim 1, wherein the acoustic transmitter and receiver are an echo sounder.

3. A sensor device according to claim 1, comprising an angle sensor capable of measuring roll and pitch angle of the sensor device.

4. A sensor device according to one of claims 1-3, comprising a processor unit arranged in the sensor unit itself or on the vessel.

5. A sensor device according to claim 1, wherein the means for communication between the sensor device and the vessel are a wireless communications device.

6. A sensor device according to claim 1, wherein the means for communication between sensor device and the vessel are a cabled connection between the sensor device and the vessel.

7. A sensor device according to claim 4, wherein the processor unit is adapted to calculate the height between the sensor device and the seabed a distance ahead of the sensor device in the direction of travel.

8. A sensor device according to claim 1, wherein the sensor device is adapted to be attached to trawl doors.

9. A sensor device according to claim 4, wherein the sensor device is adapted to be attached to the trawl.

10. A sensor device according to claim 1, wherein the acoustic transmitter is adapted to transmit the acoustic signal at an angle of 5-90 degrees.

11. A sensor device according to claim 11, wherein the acoustic transmitter is adapted to transmit the acoustic signal at an angle of 30 degrees.

12. A sensor device according to claim 1, comprising a GPS unit.

13. A sensor device according to claim 1, comprising a motor and a rotating mechanism for the purpose of adjusting the angle of the transmitted acoustic signal.

14. A method for monitoring distance to the bottom for gear during trawling operations, comprising:
transmitting an acoustic signal towards the bottom from at least one position on the gear, at a forward-pointing angle;
receiving the acoustic signal reflected from the seabed in the at least one position;
calculating the distance between the acoustic transmitter and the seabed based on the difference in time between transmission and reception of the acoustic signal and the forward-pointing angle; and
transmitting a signal to the vessel that indicates the calculated distance.

15. A method according to claim 14, wherein the acoustic signal is transmitted and received from a sensor device and wherein the method comprises measuring roll and pitch angle for the sensor device.

16. A method according to claim 14 or 15, comprising calculating the height between the lower part of the gear and the seabed a distance ahead of the sensor device in the direction of travel.

17. A method according to claim 15, wherein the signal is transmitted from the trawl doors.

18. A method according to claim 15, wherein the signal is transmitted from the trawl.

19. A method according to claim 15, wherein the signal is transmitted at an angle of 5-90 degrees relative to the vertical plane.

20. A method according to claim 15, wherein the signal is transmitted at an angle of 30 degrees relative to the vertical plane.

21. A method according to claim 15, comprising the step of carrying out global positioning using a OPS unit.

22. A method according to claim 15, comprising measuring the angle of the gear relative to the direction of travel at the position from which the acoustic signal is transmitted, and wherein the calculation of the distance takes into account this angle.
